(19) United States
(12) Patent Application Publication
(10) Pub. No.: US 2004/0112285 A1
(43) Pub. Date: Jun. 17, 2004

(54) Nozzle device, in particular for use by adhesive edge-to-edge joining of thin veneer sheets

(76) Inventors: Hardy Vesterby Hansen, Olgod (DK); Per Vesterby Hansen, Ribe (DK)

Correspondence Address: NIXON PEABODY, LLP, 401 9TH STREET, NW, SUITE 900, WASINGTON, DC, 20004-2128, US

(21) Appl. No.: 10/468,021

(22) PCT Filed: Feb. 13, 2002
(86) PCT No.: PCT/DK02/00100

(30) Foreign Application Priority Data
Feb. 14, 2001 (DK) PA 2001 00243

(51) Int. Cl. B05C 3/02

(52) U.S. Cl. 118/415; 156/546

(57) ABSTRACT

A nozzle device (2) is disclosed for spraying a fluid material, such as a hotmelt adhesive and particularly in the form of a kind of glue with a bonding time of fractions of a second, and which is suited for application on a narrow side edge (8) of an item (10), such as application upon a narrow side of a veneer sheet, more specifically on the narrow side edge (8), by edge-to-edge bonding of thin veneer sheets of mainly, though not quite, uniform thickness, as the veneer sheets in the form of lengths for mutual bonding are passed close by such nozzle device, where above and below the nozzle opening (4) there are provided guide members (12, 14), which are capable of supporting the lateral rims of the item (10) moved past the nozzle opening (4) and to be applied the sprayed material. Furthermore, there are described different embodiments and devices for these elements.

The present invention concerns a nozzle device for spraying/distributing a fluid or gaseous material such as a hotmelt adhesive, particularly in the form of a sort of glue with a bonding time of fractions of a second and with a variable setting time, and which is suited for application on a narrow side edge of an item, such as application upon a narrow side of a veneer sheet, more specifically on the narrow side edge, by edge-to-edge bonding of thin veneer sheets with largely, though not quite, uniform thickness, as the veneer sheets in the shape of lengths for mutual bonding are passed close by or in contact with such nozzle device.

Such use is described according to PCT applications nos. PCT/DK99/00666 and PCT/DK00/00654, where two narrow sides of veneer sheets are glued together, as one narrow side of one veneer sheet is moved past a nozzle spraying hotmelt adhesive against the narrow side. For achieving good gluing together, the position of the nozzle is, however, to be carefully adjusted by adjusting the nozzle position in relation to the side edge particularly in the direction of the thickness of the side edge.

By such gluing together it is important that the adhesive is brought to covering the extent of the thickness accurately, so that neither before nor after mechanical assembling of the veneer sheets adhesive comes out on the open side faces of the veneer sheets. Thus, the nozzle position is critical and is to be re-adjusted, including a possible change to another nozzle size by changing the veneer sheet thickness or by changing the adhesive.

In this connection it is important to understand that the application of adhesive taking place on the narrow side edges of the veneer sheets occurs within an area, which is narrower than the extent of the thickness of the veneer sheets, thus typically there is applied a run of adhesive, centred about the middle of the narrow side edge of a veneer sheet. In view of the fact that a said narrow side edge of veneer sheet typically has an extent of less than 1 mm, typically 0.5 mm, we are thus speaking of applying a run of adhesive less than 0.8 mm, typically 0.2-0.3 mm. This means in addition, that the distance between the said veneer narrow side edge and the nozzle opening is very small, and in some cases the veneer side edge is in contact with the nozzle opening, or the area very close to this during the application of the adhesive.

However, the thickness of a veneer sheet passing by the nozzle device is rather uniform, though subjected to small variations depending on wood sort, vein configurations in the wood, etc. This results in small variations in the gluing result. Furthermore, it is to be mentioned, that the veneer sheets during the application of adhesive are moved past the nozzle device with relatively great speed.

It is the task of the present invention to provide an improvement of the nozzle device, so that the adjusting works are reduced and simplified, respectively, and a more uniform course of the bonding result, including a very precise application and positioning of the adhesive at the narrow side edge of the veneer.

According to the invention, this is achieved by a nozzle device of the kind indicated in the introduction in that above and below the nozzle device into which the fluid or gaseous material is led for spraying/distribution there are provided guide members including at an upper guide body and at least one lower guide body, respectively, above and below the nozzle opening, which are capable of guiding the narrow side edge of the item moved past the nozzle opening, in that the lateral rims of the item to be applied the sprayed material is supported against the guide members.

By means of this embodiment, a more precise guiding of the narrow side edges of the veneer items past the nozzle opening, so that these side edges are applied a run of adhesive. In this connection it is to be mentioned that the guide members during application of adhesive on the narrow side edges of the veneer are fastened, and in reality function as a plane support ensuring that the side edges are moved past the nozzle opening and are applied adhesive in a run, the position of which is even very well-defined, and typically delimited within the borders of the thickness of the veneer items, whereby penetration out of the adhesive out upon the broad sides of the veneer is counteracted.

In this connection it is to be mentioned that from U.S. Pat. No. 2,119,213 there is known a protective device for spray pistols, comprising a spray nozzle, the mouth of which is passed through an open U-shaped screen, the ends of which are extended with curved flaps hingedly connected therewith, the free ends of which are thereby pressed against each other so that thereby is formed an opening cylindrical screen, where the said free ends can be brought in contact with edge limits of an item on a surface, where the item only is to be applied e.g. paint from the spray nozzle. The U-shaped piece of the screen is provided with a handle at the outer side for manual handling of screen and spray nozzle. It is to be mentioned here already that such a device is not applicable in connection with mutual bonding veneer items along the narrow side edges of these, as this does not allow the very precise controlling of the side edge of the veneer item in relation to the nozzle opening enabling the very precise positioning of adhesive required, cf. the above, in connection with mutual bonding veneer items along their narrow side edges. This is not the least due to the hingedly connected flaps allowing a turning of the nozzle in relation to the opening between the free ends of the curved flaps, so that the entire area situated within the limits of the flaps are sprayed by the nozzle, which is often not intended by the nozzle device. Furthermore, the hingedly connected flaps on the protective device are hardly able to be controlled manually with the precision required in connection with edge bonding of veneer items, something which will imply with great certainty that glue would appear on the veneer surfaces outside the narrow side edges, if the protective device for spray pistols indicated in U.S. Pat. No. 2,119,213 was used for this purpose.

With the intention of ensuring an optimal positioning of the nozzle opening in relation to the guide members, the nozzle device can be designed as indicated in claim 2.

By a further embodiment according to the invention as indicated in claim 3, the surfaces on the guide members facing each other and the lateral rims of the item moved past the nozzle opening, are made smooth and with a convexly curving shape.

With this further embodiment, these surfaces display such adapted curvature that with varying thickness of the item moved by and with simultaneous keeping of contact of the guide member surfaces with it, the nozzle jet, when displaying diverging jet form in direction away from the nozzle opening, will continuously hit the edge surface of the item applied with sprayed material with an achieved extension of adhesive application which is optimal for the thickness of the item. The item can also be passed by the nozzle opening with the narrow side edge in contact with the area around the nozzle opening. In connection with the succeeding description of more details by an example embodiment according to the invention, it is described more closely how this can be provided in a simple way.

By a still further embodiment of the invention as indicated in claim 4, the guide members are secured stepwise adjustable in relation to the nozzle opening and are particularly secured adjustably in steps, the size of which corresponds to adjustment setting of the guide member relative to standard thickness and kind of items moved past the nozzle device. Hereby is achieved that positioning of the adhesive on the narrow side edge of the item moved past the nozzle opening can be adjusted within the limits of the narrow side edge, i.e. it will be possible to adjust the position of the run within the said limits if e.g. there is effected an application of adhesive on the narrow side edge being narrower than its extension.

By a still further embodiment of the invention as indicated in claim 5, the position and orientation of the nozzle opening is adjustable relative to the guide members and in relation to the narrow side edge of the item moved past the nozzle opening. Hereby are achieved further adjustment possibilities for positioning and the thickness of the adhesive at the narrow side edge of the item.

By a still further embodiment according to the invention as indicated in claim 6, the guide members are made of a smooth and durable material, e.g. of chromium-plated stainless steel, whereby is achieved a long durability of the nozzle device, and the frictional resistance between the items brought into contact with the guide members becomes low.

By a still further embodiment according to the invention as indicated in claim 7, the guide members are furthermore rotatably secured, so that they may rotate under the influence of contact with items moved past the nozzle device for further reducing the frictional resistance against these.

By a still further embodiment according to the invention as indicated in claim 8, the guide members are not made fully rotationally symmetrical, but display differently shaped cone face generatrices. By the simultaneous formation, where the guide members are arranged rotatably, this enables the guide members, preferably according to a kind of marking, by stepwise rotation and suitable arresting in attained position be adapted optimally for the different items and nozzle pressures by changing between different surface configurations on the guide members.

By a still further embodiment according to the invention as indicated in claim 9, the guide members are disposed rotatably about an axis which is inclining and/or disposed eccentrically relative to the guide members as this axis position is preferably adjustable. Hereby is achieved possibility of adaptation to item having an edge face facing the nozzle opening not being oriented mainly perpendicularly to the axis of the nozzle jet, consequently by inclining side edges or by configured side edges on the items.

For adjusting the nozzle jet, according to the invention it may advantageous, as indicated in claim 10, if the nozzle tube consists of at least two tubes disposed within each other with preferably differently shaped nozzle openings in each, and where the nozzle openings in the at least two tubes disposed within each other in combination and completely or partly arranged opposite each other enable differently shape nozzle jets as well as size of the whole nozzle opening.

In the latter case it may, as indicated in claim 11, be suitable that the guide members are secured relative to each their nozzle tube, so that the guide members completely or only with orientation in at least one direction follow the position of the nozzles.

The guide members may thus also be secured to the at least one nozzle tube as with ball or needle bearings as indicated in claim 12. Hereby the friction against the items may be kept particularly low.

A further embodiment according to the invention as indicated in claim 13, it is stated that the lower guide member is constituted by a plane support above the surface of which the nozzle opening is disposed, and where the upper guide member is constituted by a thrust pad, the face of which facing the plane support by means known per se is held abutting on facing side face of an item, which is moved past the nozzle aperture.

The nozzle opening on the nozzle device according to the invention may furthermore, as indicated in claim 14, may advantageously be disposed in a recess in the nozzle tube, the recess having a rectilinear course, which is largely oriented in parallel with the direction of movement of the facing narrow side edge of an item moved past the nozzle opening. Hereby is achieved the advantage that the side edge can be applied adhesive in such a way that the side edge is in contact with area close to the nozzle opening, however without blocking the nozzle opening itself.

In a still further embodiment according to the invention, as indicated in claim 15, nozzle device can be adapted so that the rectilinear course of the recess in the nozzle tube forms an angle V with the direction of movement of the facing narrow side edge of an item moved past the nozzle opening. By this arrangement it is achieved that the fluid or gaseous material sprayed out through the nozzle opening does not form cakes or lumps between the contact area of the veneer in the recess and the nozzle opening, whereby it is ensured that the said material is applied the narrow side edge of the item moved past the nozzle opening. It is further achieved that by this angle V between the linear course of the recess in the nozzle tube and direction of movement of the facing narrow side edge of an item being passed by the nozzle opening, it is achieved that the distance between the narrow side edge and the nozzle opening becomes well defined, which means that the thickness and the spreading of the adhesive layer applied via the nozzle opening on the narrow side edge, becomes well defined at a given viscosity and feeding pressure through the nozzle device.

Furthermore, by suspending the nozzle tube pivotably arrestible, it is achieved that the angle V between the rectilinear course of the recess in the nozzle tube and the direction of movement of the facing narrow side edge of an item moved past the nozzle opening, which again means that the width of the adhesive layer applied via the nozzle device can be varied, i.e. larger angle implies greater width of the layer of adhesive.

Example embodiments of a nozzle device according to the invention are described in more details in the following with reference to the drawing in which:

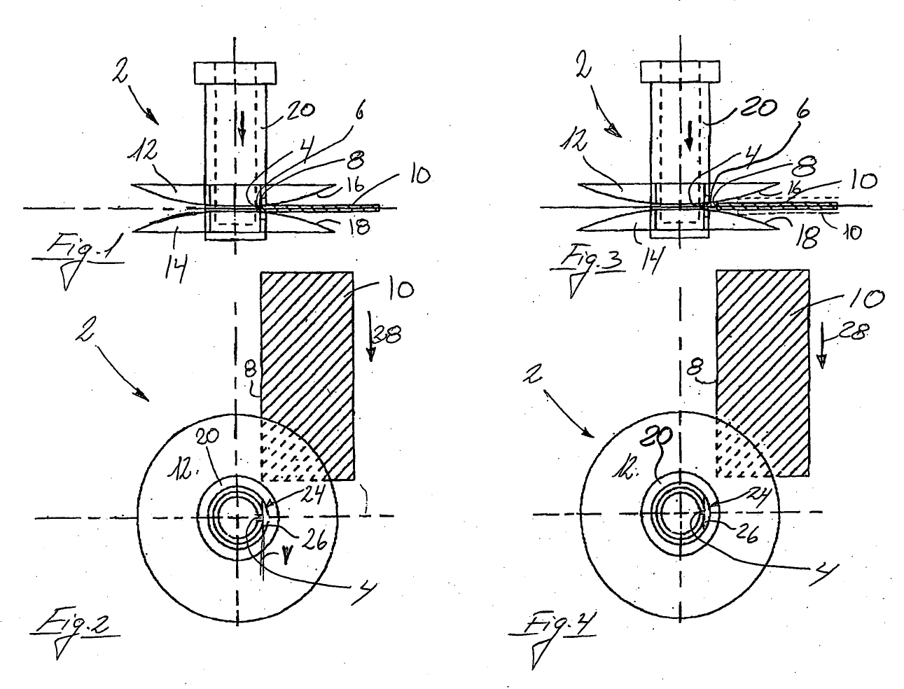

FIG. 1 shows a section through a nozzle device according to the invention where a veneer item is intended to be passed close by the nozzle opening,

FIG. 2 is a top view of the object in FIG. 1,

FIG. 3 is the same as FIG. 1, but where a veneer item is intended to be passed by the nozzle opening at a certain distance,

FIG. 4 is a top view of the object in FIG. 3,

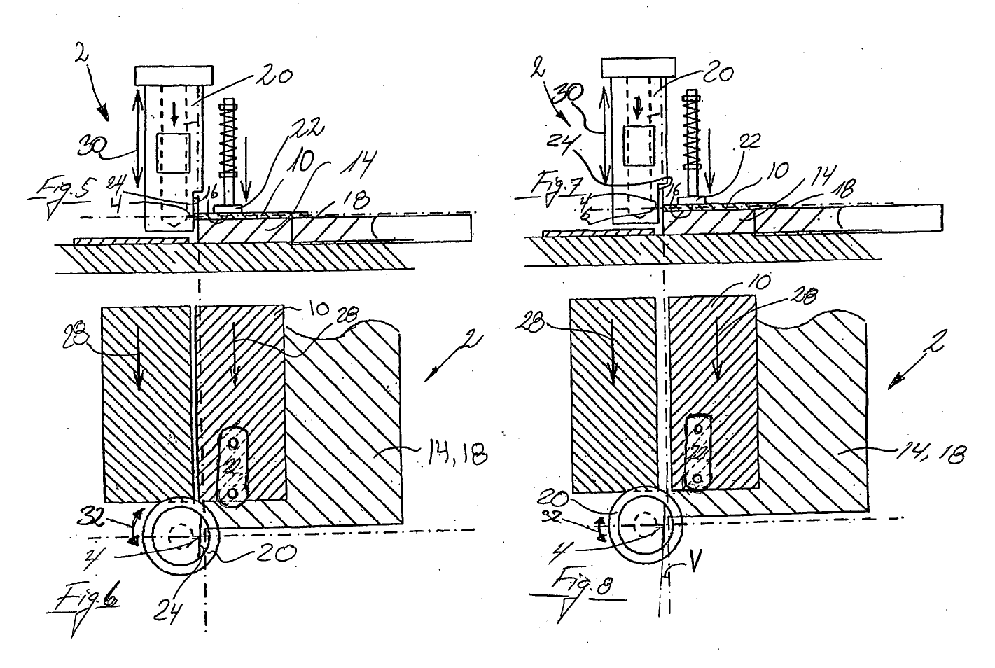

FIG. 5 shows a section through a second embodiment of a nozzle device according to the invention, where a veneer item is intended to be passed by the nozzle opening,

FIG. 6 is a top view of the object in FIG. 5,

FIG. 7 shows the same as FIG. 5, but where a veneer item is intended to be passed by the nozzle opening at a certain distance, and

FIG. 8 is a top view of the object shown in FIG. 7.

In FIGS. 1-4 there are shown an embodiment of a nozzle device 2 according to the invention. The nozzle device 2 is shown as a tube 20, which is shown as terminated downwards, but may just as well display an unfinished continuation to another nozzle, return pipe or other device. At the side of the tube 20, a nozzle opening 4 is provided from which material sprayed out supplied from above to the tube 20, as indicated with an arrow, in a not more closely indicated diverging nozzle jet 6 from the nozzle opening 4 hits a narrow side 8 on an item 10, which in the drawing (cf. FIG. 3) is shown partially with full line and partially with punctuated line indicating that the item 10 has an extent perpendicularly to the plane of the drawing and is moved past the nozzle opening 4 in this direction, and that the item 10 may very well display a not quite constant thickness during the course past the nozzle opening 4 and thus may vary in thickness between two e.g. shown thicknesses of the item 10 indicated with the stippled and the punctuated line, respectively. With a suitable thrust force, contact is maintained between the elements of the nozzle device and the item 10, whereby the item 10 is in continuous contact simultaneously at the top and at the bottom with two guide members constituted by a guide member 12 disposed over the nozzle opening 4 and a guide member 14 disposed under the nozzle opening, respectively. These guide bodies 12, 14 are here envisaged as made rotationally symmetrically around the tube 2 and are secured on this with not specified fastening means.

If the mutually facing surfaces 16, 18 of the upper guide member 12 and the lower guide member 14, respectivly, each displayed a rectilinear conical shape provided as geometrically described by means of a rectilinear conical generatrix, the distance between the nozzle opening 4 and the narrow side 8 of the item 10 would also display a linear connection in relation to the size of the thickness of the item 10.

However, with regard to the diverging course away from the nozzle opening 4 of the nozzle jet assumed here, it is so that with this geometrical design of the guide members sprayed material will come across too wide area of the side edge 8 of the item 10 compared with the desired result of the application, when large thickness of the item is present. By shaping the mutually facing surfaces 16, 18 of the guide members 12, 14 convexly as shown in the drawing, material is applied a more optimal and lesser area of the side edge 8 on the item 10 for the application concerned, when large item thickness is present, as the item 10 hereby by the convex shape of the guide members 12, 14 then are disposed relatively close to the nozzle opening 4 when the item thickness is great.

When the nozzle device 2 according to the invention is used for mutual bonding narrow sides 8 on veneer sheets 10, and the sprayed material is a hotmelt adhesive, it is suitable that the guide members 12, 14 are made of a smooth and durable material, such as e.g. chromium-plated stainless steel.

Experience shows that with this embodiment of the nozzle device according to the invention, the maximum passage speed past the nozzle device can be increased and may thus, with a sheet thickness of 0.1 to 1 mm, be increased with about 50% from e.g. a maximum passage speed of the magnitude 1 m/s to 1.5 m/s, or more. At the same time, however, the nozzle pressure in the sprayed material often has to be increased correspondingly.

It is to be mentioned that with the said relative great passage speed of the items 10, it may be advantageous that the guide members 12, 14 in FIGS. 1-4 are secured rotatably, so that they may rotate under the influence of the contact of the items 10 moved past the nozzle device 2, whereby the frictional resistance between the guide members 12, 14 and the items 10 is considerably reduced.

In FIGS. 5 to 8, a second embodiment of the nozzle device according to the invention is shown, where the guide member 14 under the nozzle opening 4 is constituted by a plane support, and where the guide member 12 over the nozzle device is constituted by a spring loaded thrust pad 22, the side 16 of which facing the guide member 14 bears against the upwardly facing side of the item 10.

It is to be mentioned that the guide member 14 under the nozzle opening 4 and the guide element 16 in the shape of the spring-loaded thrust pad 22 are supposed adjustable in vertical direction. Besides, the nozzle tube 20 is supposed vertically displaceably arrestibly suspended as indicated with the arrow 30 in FIGS. 5 and 7.

It is to be mentioned that the nozzle device 2 may advantageously be arranged so that the guide members 12, 14 are secured adjustably stepwise relative to the nozzle opening 4, and particularly secured in steps, the size of which corresponds to adjusted setting of the guide members 12, 14 relative to standard thickness and kind of items 10 passed by the nozzle device 2.

In FIGS. 1 and 5 there are shown how the narrow side edge 8 of the item 10 moved past the nozzle opening 4 is passed very closed by the nozzle opening 4, where the narrow side edge 8 actually is in contact with the periphery of the nozzle tube 20. It is to be mentioned that the nozzle opening 4 is disposed in a recess 24 in the wall of the nozzle tube 20. In the shown embodiment, the recess 24 has a rectilinear course 26 forming an angle V with the direction of movement of the narrow side edge 8 of the item 10, as indicated with the arrow 28. Hereby is achieved a very accurate distribution of the adhesive 6 upon the narrow side edge 8 of the item 10.

Furthermore, it is noted that in such cases described by way of example, it has appeared advantageous for achieving a good adhesive distribution on the item that the nozzle jet 6 is not directed perpendicularly towards the narrow side of the veneer sheet, but is directed some degrees, preferably 3 to 100, away from this perpendicular orientation in the direction of movement of the sheet.

The nozzle tube 20 is therefore in a way known per se suspended pivoting and arrestible so that it is pivoting about it horizontal axis, which has the advantage that the distance between the nozzle opening 4 and the narrow side edge 8 on an item 10, in case the narrow side edge 8 touches the nozzle tube 20 during the passing, will be even very well defined, and the distance may be adjusted by turning the arrestible, pivotably suspended nozzle tube 20.

List of Reference Numbers

2: nozzle device

4: nozzle opening in 2, 20

6: glue for distributing via 4

8: a narrow side edge on 10

10: item, typically a veneer item

12: guide member over the nozzle opening 4

14: guide member under the nozzle opening 4

16: side of 12 facing 14

18: side of 14 facing 12

20: cylindrical nozzle tube

22: thrust pad

24: recess in 20

26: rectilinear course of 24

28: direction of movement of the facing narrow side edge 8 of the item 10

30: direction in which the nozzle tube 20 is vertically displaceable

32: direction in which the nozzle tube 20 may be turned/arrested

1. A nozzle device (2), including a nozzle opening (4) for spraying/distributing a fluid or gaseous material (6) such as a hotmelt adhesive and particularly in the form of a kind of glue with a bonding time of fractions of a second, and with a variable setting time, and which is suited for application on a narrow side edge (8) of an item (10), such as application upon a narrow side of a veneer sheet, more specifically on the narrow side edge (8), by edge-to-edge bonding of thin veneer sheets (10) largely, though not quite, uniform thickness, as the veneer sheets (10) in the shape of lengths for mutual bonding are passed close by or in contact with such nozzle device (2), characterised in that the nozzle device (4) is formed as at least one side aperture (4) in a cylindrical tube (20) and that above and below the nozzle device (2) into which the fluid or gaseous material (6) is led for spraying/distribution there are provided guide members (12, 14) including at an upper guide body (12) and at least one lower guide body (14), respectively, above and below the nozzle opening (4), which are capable of guiding the narrow side edge (8) of the item (10) moved past the nozzle opening (4), in that the lateral rims of the item (10) to be applied the sprayed material (6) is supported against the guide members (12, 14).

2. A nozzle device (2) according to claim 1, characterised in that the faces (16,18) on the guide members (12, 14) facing the lateral rims of the item (10) moved past the nozzle opening (4) and facing each other are made smooth and with a convexly curving course.

3. A nozzle device (2) according to claim 1 or 2, characterised in that the guide members (12, 14) area secured stepwise adjustable in relation to the nozzle opening (4) and are particularly secured adjustably in steps, the size of which corresponds to adjustment setting of the guide member (12, 14) relative to standard thickness and kind of items (10) moved past the nozzle device (2).

4. A nozzle device (2) according to any of claims 1-3, characterised in that the position and orientation of the nozzle opening (4) is adjustable in relation to the guide members (12, 14) and in relation to the narrow side edge (8) of the item (10) moved past the nozzle opening (4).

5. A nozzle device (2) according to any of claims 1-4, characterised in that guide members (12, 14) are made of a smooth and durable material, such as e.g. chromium-plated stainless steel.

6. A nozzle device (2) according to any of claims 1-5, characterised in that the guide members (12, 14) are furthermore secured rotatably, so that they can rotate under the influence of contact with items (10) moved past the nozzle device (2) for reducing the frictional resistance against these.

7. A nozzle device (2) according to any of claims 1-6, characterised in that the guide members (12, 14) are not fully rotationally symmetric but display differently shaped cone surface generatrices.

8. A nozzle device (2) according to any of claims 1-7, characterised in that the guide members (12, 14) are disposed rotatably about an axis which is inclining and/or disposed eccentrically relative to the guide members (12, 14) as this axis position is preferably adjustable.

9. A nozzle device (2) according to any of claims 1-8, characterised in that the nozzle tube (20) consists of at least two tubes disposed within each other with preferably differently shaped nozzle openings (4) in each, and where the nozzle openings (4) in the at least two tubes disposed within each other in combination and completely or partly arranged opposite each other enable differently shape nozzle jets as well as size of the whole nozzle opening.

10. A nozzle device (2) according to claim 9, characterised in that the guide members (12, 14) are fixed in relation to each their nozzle tube (20) so that the guide members (12, 14) completely or only with orientation in at least one direction follow the setting of the tubes (2).

11. A nozzle device (2) according to any of claims 1-10, characterised in that the guide members (12, 14) are secured to the at least one nozzle tube (20) as with ball or needle bearings.

12. A nozzle device (2) according to any of claims 1, 3, 4 5, 8, 9 or 2, characterised in that the lower guide member (14) is constituted by a plane support above the surface (18) of which the nozzle opening (4) is disposed, and where the upper guide member (12) is constituted by a thrust pad (22), the face (16) of which facing the plane support by means known per se is held abutting on facing side face of an item (10), which is moved past the nozzle aperture (4).

13. A nozzle device (2) according to any of claim 1-12, characterised in that the nozzle aperture (4) is disposed in a recess (24) in the nozzle tube (20), the recess (24) having a rectilinear course (24), which is largely oriented in parallel with the direction of movement (28) of the facing narrow side edge (8) of an item (10) moved past the nozzle opening (4).

14. A nozzle device (2) according to claim 13, characterised in that the rectilinear course (26) of the recess (24) in the nozzle tube (20) forms an angle V with the direction of movement (28) of the facing narrow side edge (8) of an item (10) moved past the nozzle opening (4).

15. A nozzle device (2) according to claim 13 or 14, characterised in that the angle V between the rectilinear course (26) of the recess (24) in the nozzle tube (20) and the direction of movement (28) of the facing narrow side edge (8) of an item (10) moved past the nozzle opening (4) is adjustable by the nozzle tube (20) being pivotably, arrestibly suspended.
